(19) United States
(12) Patent Application Publication
(10) Pub. No.: US 2017/0052497 A1
(43) Pub. Date: Feb. 23, 2017

(54) RECORDING-MEDIUM SUPPLYING DEVICE AND IMAGE FORMING APPARATUS

(71) Applicant: FUJI XEROX Co., Ltd., Tokyo (JP)

(72) Inventor: Eiji INOUE, Kanagawa (JP)

(73) Assignee: FUJI XEROX Co., Ltd., Tokyo (JP)

(21) Appl. No.: 15/042,285

(22) Filed: Feb. 12, 2016

(30) Foreign Application Priority Data
Aug. 20, 2015 (JP) 2015-162648

(51) Int. Cl. G03G 15/00; B65H 1/26; B65H 1/04

(52) U.S. Cl. CPC G03G 15/6529; B65H 1/04; B65H 1/266; B65H 2405/1122; B65H 2405/1144; B65H 2801/12

(57) ABSTRACT

A recording-medium supplying device includes a device body, a guide member that guides a side edge of a recording medium contained in the device body, an extension mechanism that extends the device body in accordance with a size of the recording medium, an extension cancellation member that disengages the extension mechanism and the device body from each other, and a partition wall that partitions the guide member and the extension cancellation member from each other.

### CROSS-REFERENCE TO RELATED APPLICATIONS

This application is based on and claims priority under 35 USC 119 from Japanese Patent Application No. 2015-162648 filed Aug. 20, 2015.

### BACKGROUND

Technical Field

The present invention relates to a recording-medium supplying device and an image forming apparatus.

### SUMMARY

According to an aspect of the invention, there is provided a recording-medium supplying device including a device body, a guide member that guides a side edge of a recording medium contained in the device body, an extension mechanism that extends the device body in accordance with a size of the recording medium, an extension cancellation member that disengages the extension mechanism and the device body from each other, and a partition wall that partitions the guide member and the extension cancellation member from each other.

### BRIEF DESCRIPTION OF THE DRAWINGS

An exemplary embodiment of the present invention will be described in detail based on the following figures, wherein:

FIG. 1 is a sectional view of an image forming apparatus according to an exemplary embodiment of the present invention;

FIG. 2 is a top view of a recording-medium supplying device included in the image forming apparatus illustrated in FIG. 1;

FIG. 3 is a perspective view of a section around a guide member (end guide) and an extension cancellation member in the recording-medium supplying device illustrated in FIG. 2;

FIG. 4 is a perspective view of the guide member (end guide) according to the exemplary embodiment of the present invention;

FIGS. 5A and 5B are vertical sectional views illustrating the structure of the guide member (end guide) according to the exemplary embodiment of the present invention;

FIG. 6 is a top view illustrating the structure of an extension mechanism according to the exemplary embodiment of the present invention in a first position (normal state) in which the cassette body receives normal recording media;

FIG. 7 is a top view illustrating the structure of the extension mechanism according to the exemplary embodiment of the present invention in a state in which the extension cancellation member is rotated; and

FIG. 8 is a top view illustrating the structure of the extension mechanism according to the exemplary embodiment of the present invention in a second position (extended state) in which the cassette body is extended.

### DETAILED DESCRIPTION

Next, an exemplary embodiment of the present invention will be described with reference to the drawings.

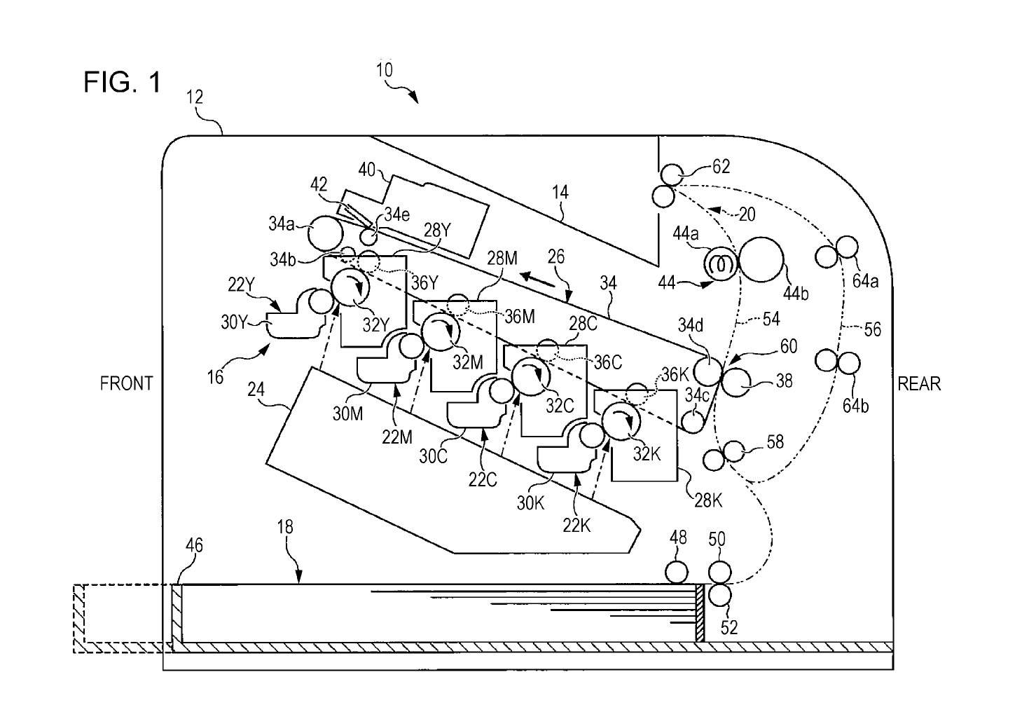

FIG. 1 is a sectional view of an image forming apparatus 10 according to an exemplary embodiment of the present invention.

The image forming apparatus 10 includes an apparatus body 12.

The apparatus body 12 has a top surface that serves as an output unit 14 to which a recording medium having an image formed thereon is output.

The apparatus body 12 includes an image forming section 16 that forms an image to be transferred to a recording medium, a recording-medium supplying device 18 that supplies the recording medium to the image forming section 16, and a transport path 20 along which the recording medium supplied by the recording-medium supplying device 18 is transported to the output unit 14.

The image forming section 16 includes, for example, four developer-image forming units 22Y, 22M, 22C, and 22K, an optical write device 24, and a transfer device 26.

The developer-image forming units 22Y, 22M, 22C, and 22K respectively form developer images by using yellow (Y), magenta (M), cyan (C), and black (K) developers.

In the following description, the letters Y, M, C, and K representing the respective colors may be omitted, and the developer-image forming units 22Y, 22M, 22C, and 22K, for example, may be generically referred to as developer-image forming units 22. This also applies to other components, such as photoconductor units 28 and developing devices 30, provided for the respective colors.

The developer-image forming units 22Y, 22M, 22C, and 22K include photoconductor units 28Y, 28M, 28C, and 28K, respectively, and developing devices 30Y, 30M, 30C, and 30K, respectively.

The photoconductor units 28Y, 28M, 28C, and 28K are arranged in that order from the rear side of the apparatus body 12 (left side in FIG. 1).

The photoconductor units 28Y, 28M, 28C, and 28K serve as image forming structures and include photoconductor drums 32Y, 32M, 32C, and 32K, respectively.

The photoconductor drums 32 serve as image carriers.

The developing devices 30Y, 30M, 30C, and 30K develop latent images formed on the corresponding photoconductor drums 32Y, 32M, 32C, and 32K by using Y, M, C, and K developers contained therein.

The optical write device 24 serves as a latent-image forming device, and forms latent images on the surfaces of the photoconductor drums 32Y, 32M, 32C, and 32K by irradiating the photoconductor drums 32 with light.

The transfer device 26 includes an intermediate transfer belt 34 that serves as a transfer body, first transfer rollers 36Y, 36M, 36C, and 36K that serve as first transfer devices, a second transfer roller 38 that serves as a second transfer device, and a cleaning device 40.

The intermediate transfer belt 34 is an endless belt, and is supported by, for example, five support rollers 34a, 34b, 34c, 34d, and 34e such that the intermediate transfer belt 34 is rotatable in the direction shown by the arrow in FIG. 1. At least one of the support rollers 34a, 34b, 34C, 34d, and 34e is connected to a motor (not shown) and rotates when a driving force is transmitted thereto from the motor, so that the intermediate transfer belt 34 is rotated.

The first transfer rollers 36Y, 36M, 36C, and 36K transfer the developer images formed on the surfaces of the photoconductor drums 32Y, 32M, 32C, and 32K by the corresponding developing devices 30Y, 30M, 30C, and 30K onto the intermediate transfer belt 34.

The Y, M, C, and K developer images that have been transferred onto the intermediate transfer belt 34 are transferred onto the recording medium by the second transfer roller 38.

The cleaning device 40 includes a scraping member 42 that scrapes off toners contained in the developers of the respective colors that remain on the surface of the intermediate transfer belt 34 after the developer images of the respective colors have been transferred onto the recording medium by the second transfer roller 38. The toners that have been scraped off by the scraping member 42 are collected in the cleaning device 40.

The apparatus body 12 also includes a fixing device 44 that fixes the developer images that have been transferred onto the recording medium by the second transfer roller 38 to the recording medium.

The recording-medium supplying device 18 includes a device body 46 that contains a stack of recording media; a feeding roller 48 that feeds the top recording medium of the stack contained in the device body 46 toward the image forming section 16; a transport roller 50 that transports the recording medium fed by the feeding roller 48; and a retard roller 52 that separates the recording media from each other to prevent the recording media from being transported to the image forming section 16 in a stacked state.

The transport path 20 includes a first transport path 54 and a second transport path 56.

The first transport path 54 allows the recording medium supplied from the recording-medium supplying device 18 to be transported to the image forming section 16, and then be output to the output unit 14 after an image is formed thereon. The feeding roller 48, the transport roller 50, the retard roller 52, registration rollers 58, a transfer unit 60, a fixing device 44, and output rollers 62 are arranged along the first transport path 54 in that order from the upstream side in the direction in which the recording medium is transported.

The registration rollers 58 adjust the time at which the recording medium is transported to the transfer unit 60. The registration rollers 58 temporarily stops the leading end of the recording medium that has been transported from the recording-medium supplying device 18, and then transports the recording medium toward the transfer unit 60 at a time that matches the time at which the image is formed.

The fixing device 44 includes a heating roller 44a and a pressing roller 44b, and fixes the developer image to the recording medium by heating and pressing the recording medium that passes through a space between the heating roller 44a and the pressing roller 44b.

The output rollers 62 output the recording medium to the output unit 14 after the developer is fixed to the recording medium by the fixing device 44.

The second transport path 56 is used to transport the recording medium to the registration rollers 58 again after a developer image has been transferred onto one side of the recording medium by the transfer unit 60. The recording medium is reversed while being transported so that another developer image may be transferred onto the other side thereof.

Two pairs of reverse transfer rollers 64a and 64b, for example, are arranged along the second transport path 56.

In the case where duplex printing is performed, the output rollers 62 are rotated in the reverse direction while the trailing end portion of the recording medium that has been transported from the first transport path 54 to the output rollers 62 is nipped therebetween, so that the recording media is supplied to the reversed transport path 56. The recording medium that has been supplied to the second transport path 56 is transported to a region upstream of the registration rollers 58 by the reverse transfer rollers 64a and 64b.

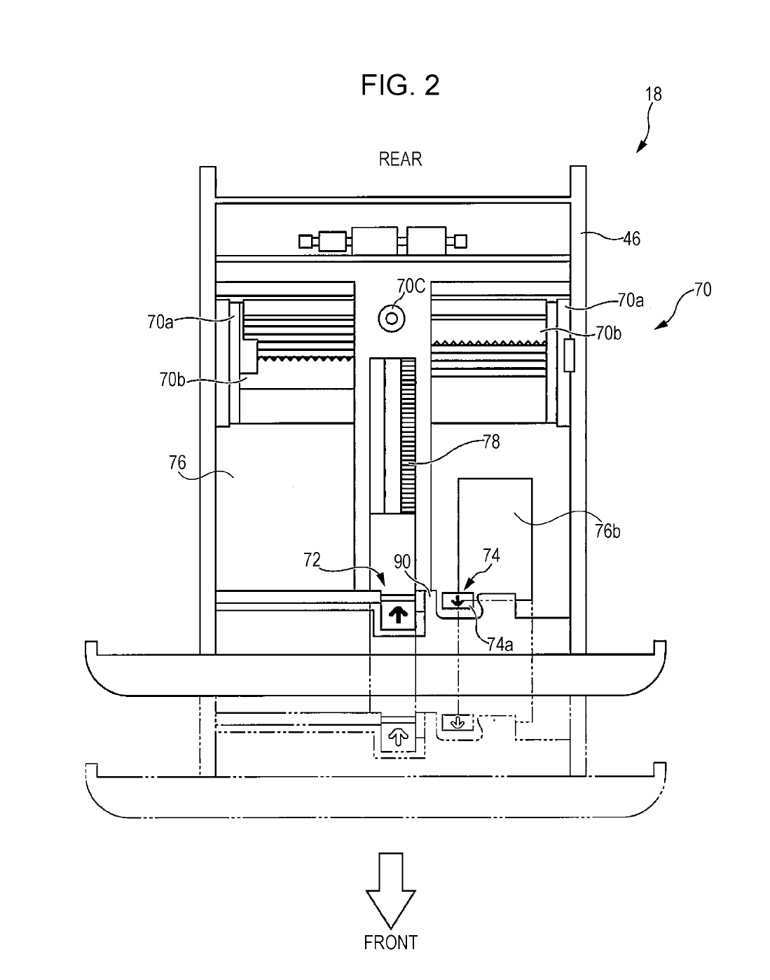

FIG. 2 illustrates the recording-medium supplying device 18 according to the present exemplary embodiment.

The recording-medium supplying device 18 is capable of being pulled out of the apparatus body 12 toward the front side (left side in FIG. 1). In addition, the recording-medium supplying device 18 is extendable toward the front side (left side in FIG. 1 and bottom side in FIG. 2) so that recording media of a size greater than or equal to A4 size, such as legal size, may be contained therein.

The recording-medium supplying device 18 includes the device body 46 (hereinafter referred to as a cassette body 46) that contains the recording media, such as sheets of paper; a guide member 70 (side guide) that guides both side edges of the stack of recording media contained in the cassette body 46 in a direction perpendicular to the longitudinal direction; a guide member 72 (end guide) that guides one edge (rear edge) of the stack of recording media contained in the cassette body 46 in the longitudinal direction; and an extension mechanism 74 which extends the cassette body 46 in accordance with the size of the recording media contained in the cassette body 46 in the longitudinal direction.

The cassette body 46 has the shape of a rectangular box with an open top, and is capable of receiving the recording media through the opening at the top. The cassette body 46 includes a receiving unit 76 that is disposed in the box-shaped cassette body 46 and receives the recording media, and a slide unit 78 along which the guide member 72 may be slid.

The guide member 70 includes guide plates 70a that come into contact with the side edges of the stack of recording media to position the recording media, racks 70b that are attached to the guide plates 70a, and a pinion 70c that engages with the racks 70b and rotates with respect to the receiving unit 76. Here, two guide plates 70a and two racks 70b are provided. When one guide plate 70a is caused to slide, the rack 70b attached to this guide plate 70a also slides, so that the pinion 70c is rotated. When the pinion 70c is rotated, the other rack 70b is caused to slide, so that the other guide plate 70a also slides. Therefore, when the position of one guide plate 70a is adjusted, the position of the other guide plate 70a is adjusted accordingly. In the present exemplary embodiment, the guide plate 70a and the rack 70b at one side are respectively symmetrical with the guide plate 70a and the rack 70b at the other side about the pinion 70c. Thus, the guide plates 70a are capable of guiding the recording media so that the recording media are disposed at the center of the cassette body 46.

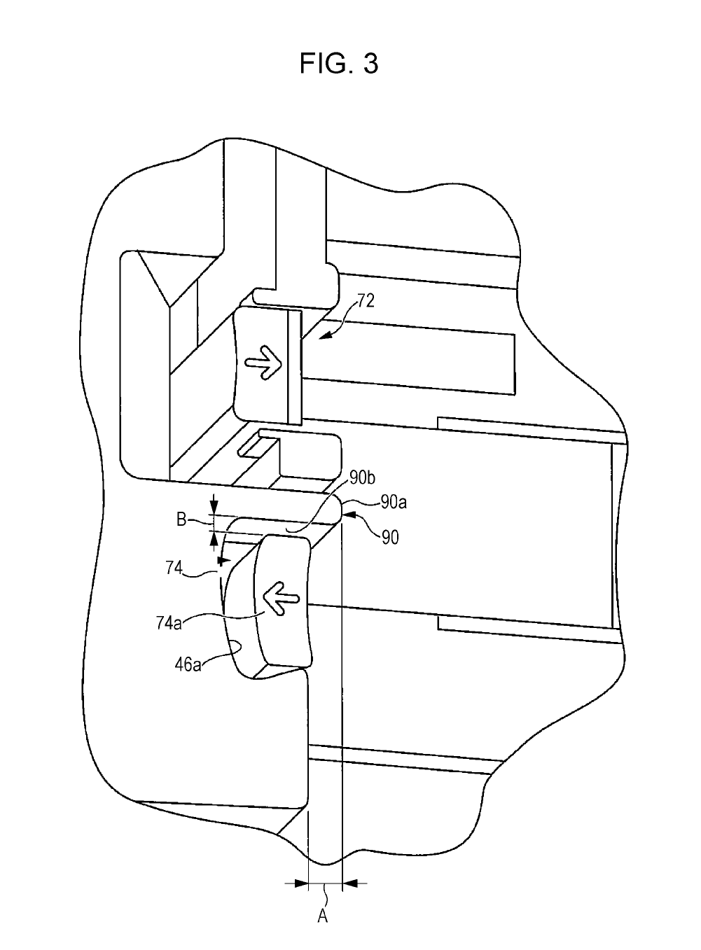

FIG. 3 is a perspective view of a section around the guide member 72 and an extension cancellation member 74a with which the extension mechanism 74 is operated in the recording-medium supplying device.

The guide member 72 is operated in the direction shown by the arrow in accordance with the position of an end of the stack of recording media. Accordingly, the guide member 72 is moved in the direction in which it is operated. The extension cancellation member 74a is operated in the direction shown by the arrow when the cassette body 46 is to be extended. Accordingly, the extension mechanism 74 is rotated and the cassette body 46 is extended in the longitudinal direction of the recording media.

As illustrated in FIG. 3, a partition wall 90 is provided between the guide member 72 and the extension cancellation member 74a. The guide member 72 and the extension cancellation member 74a are arranged next to each other with the partition wall 90 disposed therebetween.

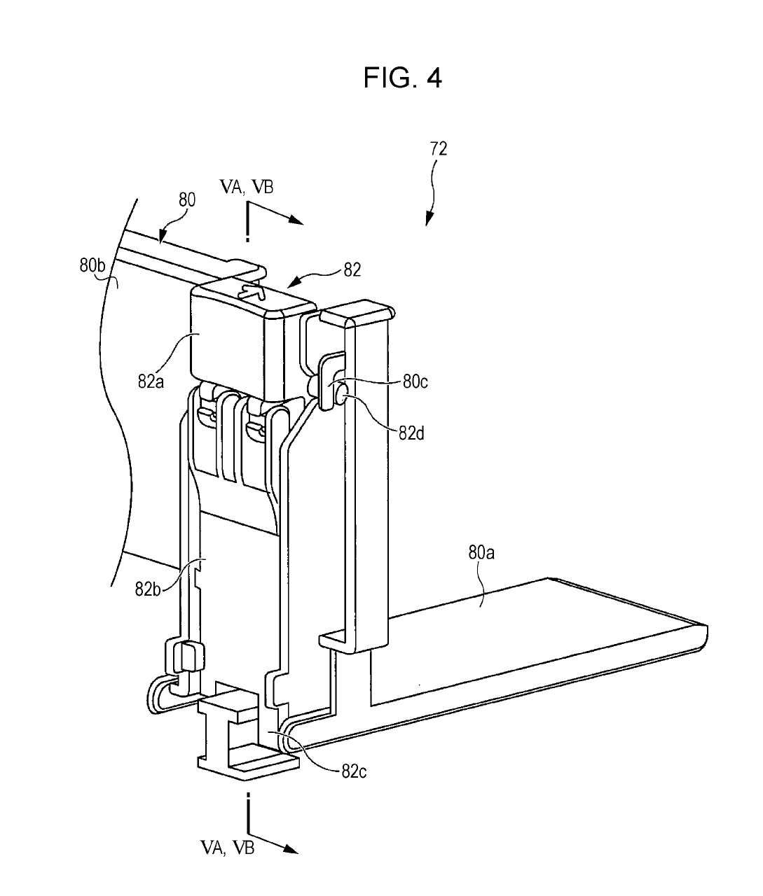

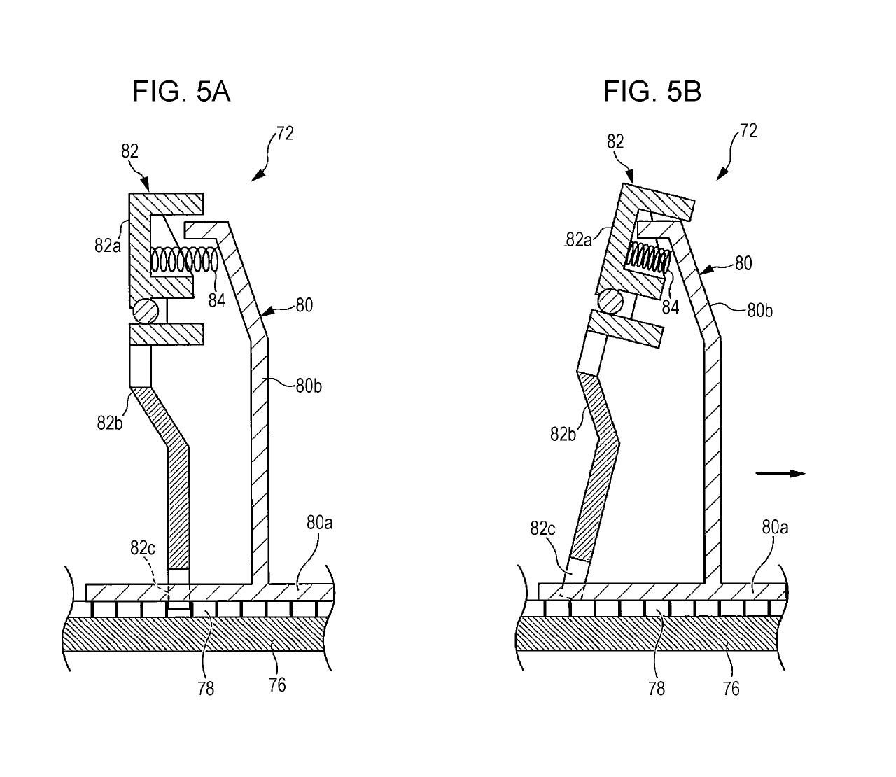

FIG. 4 is a perspective view illustrating the structure of the guide member 72. FIGS. 5A and 5B are sectional views taken along line VA,VB-VA,VB in FIG. 4, illustrating the operation of the guide member 72.

The guide member 72 includes a guiding member 80 that guides one end of the stack of recording media, and a positioning member 82 that positions the guiding member 80 with respect to the receiving unit 76. The positioning member 82 is slidable along and engageable with the slide unit 78 formed on the receiving unit 76. The position at which the positioning member 82 engages with the slide unit 78 is changeable in accordance with the size of the recording media that are contained.

The guiding member 80 includes a base portion 80a disposed on the top surface of the receiving unit 76; a guide portion 80b that stands substantially upright on the base portion 80a; and support members 80c that support the positioning member 82 in a rotatable manner.

The positioning member 82 includes a guide-unit operation portion 82a that is operated by an operator; a leg portion 82b that supports the guide-unit operation portion 82a; and an engagement projection 82c that is provided at the bottom end of the leg portion 82b and engages with the slide unit 78 formed on the receiving unit 76.

The guide-unit operation portion 82a is curved in the direction of operation thereof to facilitate operation by the operator. In addition, an arrow indicating the direction of operation is provided on the top surface of the guide-unit operation portion 82a. Shafts 82d are provided on both sides of the guide-unit operation portion 82a, and are supported by the above-described support members 80c. The guide-unit operation portion 82a is angular U-shaped in cross section, and an urging member 84, such as a compression spring, is disposed therein. The guide-unit operation portion 82a and the guide portion 80b are urged by the urging member 84.

When the operator applies a force to the guide-unit operation portion 82a in the direction indicated by the arrow, the engagement projection 82c is moved around the shafts 82d and released from an engagement groove formed in the slide unit 78 (FIG. 5B), so that the guide member 72 becomes movable in the direction of operation in accordance with the size of the recording media. When no force is applied by the operator, the engagement projection 82c of the positioning member 82 is engaged with the engagement groove in the slide unit 78 owing to the urging force applied by the urging member 84, so that the guide member 72 is positioned at a certain position (FIG. 5A).

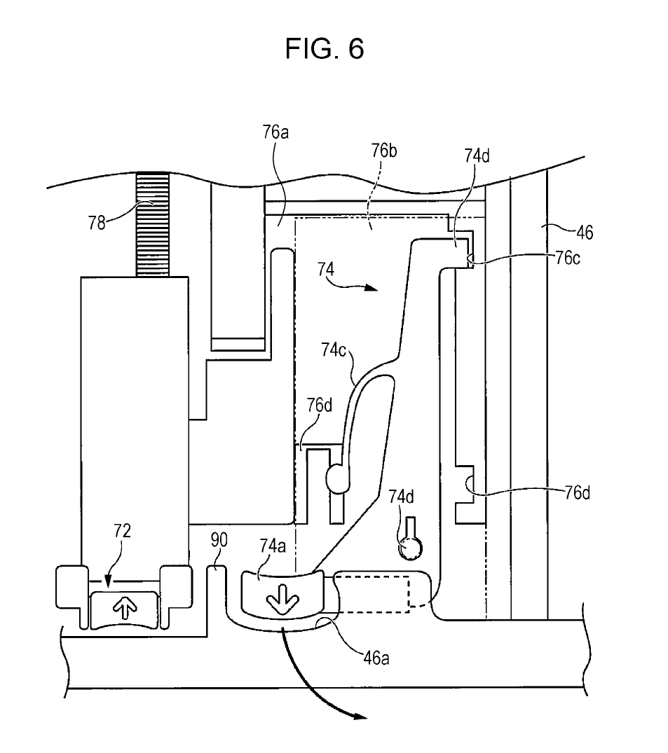

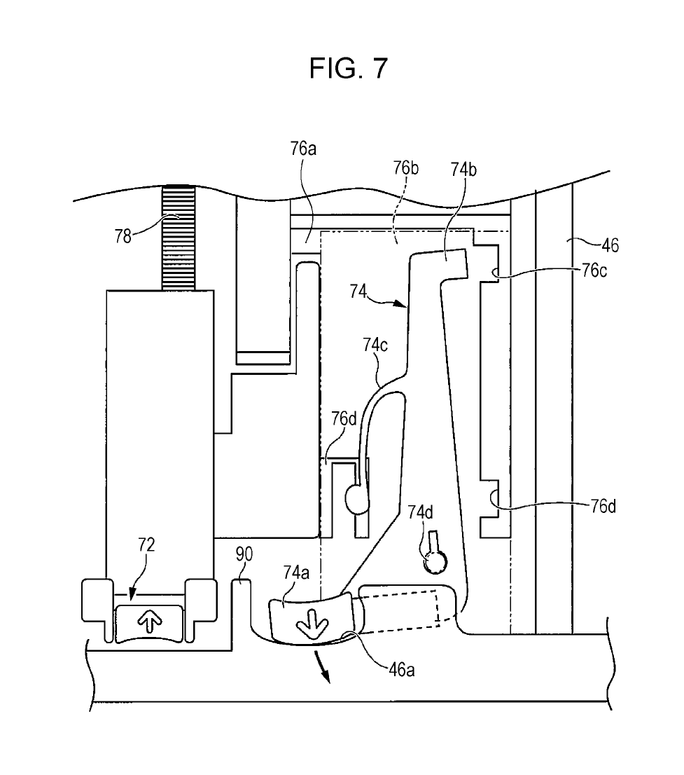

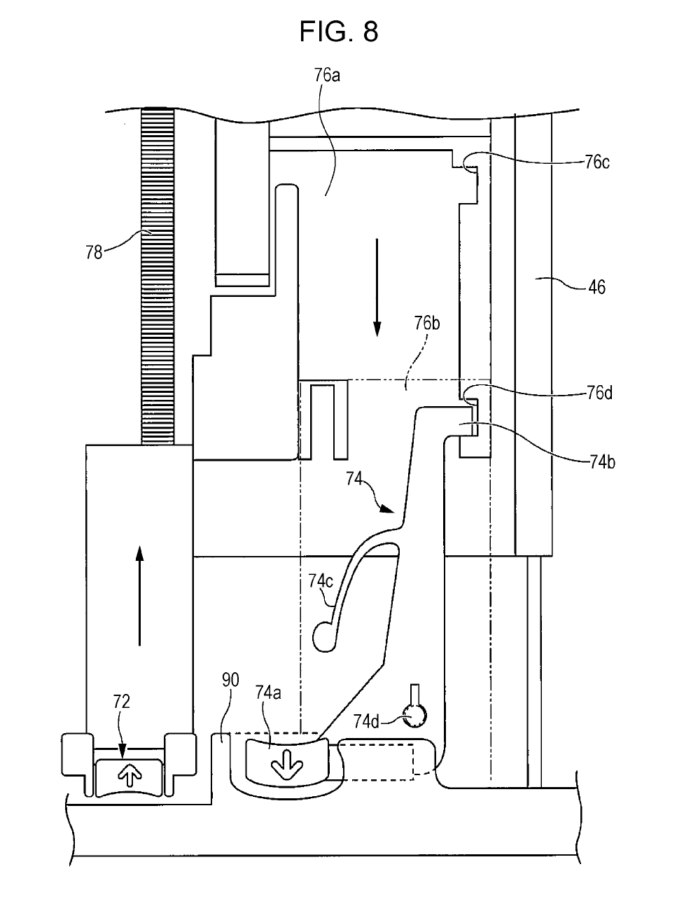

FIGS. 6 to 8 illustrate the detailed structure of the extension mechanism 74. In FIGS. 6 to 8, to facilitate explanation of the operation of the extension mechanism 74, a receiving plate 76b that covers the extension mechanism 74 and supports a rotation support 74d of the extension mechanism 74, which will be described below, at the top surface of the rotation support 74d is omitted.

The receiving unit 76 includes a receiving surface 76a provided below the receiving plate 76b of the receiving unit 76. The extension mechanism 74 is disposed on the receiving surface 76a, and the top surface of the extension mechanism 74 is covered with the receiving plate 76b.

The extension mechanism 74 moves along the receiving surface 76a together with the receiving plate 76b.

A first engagement portion 76c and a second engagement portion 76d to which the extension mechanism 74 may be engaged are provided on the receiving surface 76a. An engagement portion 74b of the extension mechanism 74, which will be described below, engages with the first engagement portion 76c or the second engagement portion 76d.

The extension mechanism 74 includes the engagement portion 74b that engages with the cassette body 46 (first engagement portion 76c or second engagement portion 76d); the extension cancellation member 74a that disengages the engagement portion 74b from the cassette body 46; an urging member 74c that is, for example, a resin spring and that urges the cassette body 46 at a first position, which will be described below; and the rotation support 74d which supports the extension mechanism 74 in a rotatable manner.

The engagement portion 74b engages with the first engagement portion 76c on the receiving unit 76 of the cassette body 46 to allow the cassette body 46 to be held at a first position (normal position). The cassette body 46 is held at the first position when, for example, A4 size recording media, which are usually used, are contained.

The engagement portion 74b engages with the second engagement portion 76d on the receiving unit 76 of the cassette body 46 to allow the cassette body 46 to be held at a second position (extended position). The cassette body 46 is held at the second position when recording media having a size greater than that of the normally used recording media in the longitudinal direction are contained.

The extension cancellation member 74a is disposed in a recess 46a formed in the cassette body 46. The recess 46a is long in a direction in which the extension cancellation member 74a is operated (rotated). An arrow indicating the direction of operation is provided on the top surface of the extension cancellation member 74a. The extension cancellation member 74a is recessed in the direction of operation so that the operator may easily hold the extension cancellation member 74a.

The urging member 74c is, for example, a resin spring. An end portion of the urging member 74c engages with a groove 76d formed in the receiving surface 76a so that the cassette body 46 is held at the first position.

The rotation support 74d is supported by the bottom surface of the receiving plate 76b that covers the extension mechanism 74. When a force is applied to the extension cancellation member 74a in the direction indicated by the arrow, the extension mechanism 74 is rotated such that the rotation support 74d serves as a fulcrum.

The operation of the extension mechanism 74 will now be described.

When a force is applied to the extension cancellation member 74a in the direction indicated by the arrow, the extension mechanism 74 is rotated counterclockwise around the rotation support 74d and disengaged from the first engagement portion 76c (normal state, first position). The cassette body 46 is extended toward the front side, and the extension mechanism 74 is engaged with the second engagement portion 76d and secured (extended state, second position).

As illustrated in FIG. 3, the extension cancellation member 74a is separated from an end portion 90a of the partition wall 90 by a distance A, which is, for example, about 5 mm, in a direction away from the recording media placed on the receiving unit 76 in the longitudinal direction of the recording media. The extension cancellation member 74a is separated from a side surface 90b of the partition wall 90 that is adjacent to the extension cancellation member 74a by a distance B, which is, for example, about 2 mm. The recess 46a is large in the direction of operation (rotation) of the extension cancellation member 74a.

The extension cancellation member 74a is arranged next to the guide member 72 with the partition wall 90 provided therebetween. The extension cancellation member 74a is operated in the recess 46a in a direction different from the direction in which the guide member 72 is operated, so that the extension mechanism 74 is rotated counterclockwise. Then, the cassette body 46 is moved between the first position that corresponds to the normal state and the second position that corresponds to the extended state.

The present invention is not limited to the above-described exemplary embodiment, and various modifications are possible without departing from the spirit of the present invention.

As described above, the present invention may be applied to image forming apparatuses such as copy machines, printers, and facsimile devices.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording-medium supplying device comprising:
a device body;
a guide member that guides a side edge of a recording medium contained in the device body;
an extension mechanism that extends the device body in accordance with a size of the recording medium;
an extension cancellation member that disengages the extension mechanism and the device body from each other; and
a partition wall that partitions the guide member and the extension cancellation member from each other.

2. A recording-medium supplying device comprising:
a device body;
a guide member that guides a side edge of a recording medium contained in the device body;
an extension mechanism that extends the device body in accordance with a size of the recording medium; and
an extension cancellation member that disengages the extension mechanism and the device body from each other,
wherein the guide member is moved in an operation direction to guide the side edge of the recording medium, and
wherein the extension cancellation member is rotated in a rotational direction to disengage the extension mechanism and the device body from each other.

3. The recording-medium supplying device according to claim 1, wherein the guide member is moved in an operation direction to guide the side edge of the recording medium, and the extension cancellation member is rotated in a rotational direction to disengage the extension mechanism and the device body from each other.

4. The recording-medium supplying device according to claim 1,
wherein the extension cancellation member includes
an engagement portion that engages with the device body, and
a rotation support that supports the extension cancellation member such that the extension cancellation member is rotatable relative to the device body.

5. The recording-medium supplying device according to claim 2,
wherein the extension cancellation member includes
an engagement portion that engages with the device body, and
a rotation support that supports the extension cancellation member such that the extension cancellation member is rotatable relative to the device body.

6. The recording-medium supplying device according to claim 3,
wherein the extension cancellation member includes
an engagement portion that engages with the device body, and
a rotation support that supports the extension cancellation member such that the extension cancellation member is rotatable relative to the device body.

7. An image forming apparatus comprising:
a recording-medium supplying device including
a device body,
a guide member that guides a side edge of a recording medium contained in the device body,
an extension mechanism that extends the device body in accordance with a size of the recording medium,
an extension cancellation member that disengages the extension mechanism and the device body from each other, and
a partition wall that partitions the guide member and the extension cancellation member from each other.

8. An image forming apparatus comprising:
a recording-medium supplying device including
a device body;
a guide member that guides a side edge of a recording medium contained in the device body,
an extension mechanism that extends the device body in accordance with a size of the recording medium, and
an extension cancellation member that disengages the extension mechanism and the device body from each other,
wherein the guide member is moved in an operation direction to guide the side edge of the recording medium, and
wherein the extension cancellation member is rotated in a rotational direction to disengage the extension mechanism and the device body from each other.

9. The image forming apparatus according to claim 7, wherein the guide member is moved in an operation direction to guide the side edge of the recording medium, and the extension cancellation member is rotated in a rotational direction to disengage the extension mechanism and the device body from each other.
